(19) United States
(12) Patent Application Publication
(10) Pub. No.: US 2014/0268776 A1
(43) Pub. Date: Sep. 18, 2014

(54) FLAT LAMP

(71) Applicant: Steve LEE, Park Ridge, IL (US)

(72) Inventor: Steve LEE, Park Ridge, IL (US)

(21) Appl. No.: 13/834,967

(22) Filed: Mar. 15, 2013

(51) Int. Cl. F21V 21/32

(52) U.S. Cl. CPC F21V 21/32
USPC 362/249.04; 362/249.01; 362/249.02

(57) ABSTRACT

A lamp including a base, a neck and a lamp head. The lamp head includes first and second parallel major planar faces and a minor face perpendicular to the first and second parallel major planar faces and disposed therebetween. The first and second parallel major planar faces congruently form an outline of a selected light-associated object. The lamp head further includes first and second light emitting sources disposed between the first and second parallel major planar faces. The first light emitting source externally emits light via at least a portion of the minor face. The second light emitting source projects light to at least selectively illuminate at least a portion of the outlined light-associated object.

### BACKGROUND OF THE INVENTION

1. Field of the Invention

This invention relates generally to lamps and, more specifically, to a lamp providing or having a relatively flat profile.

2. Discussion of Related Art

Many conventional lamps have or provide a three dimensional structure. While such three dimensional structures may be desired as visually pleasing, such structures can be difficult or challenging to store, package, transport or the like such as prior to final desired lamp location placement.

Further, while lamps are a form of light fixture that has become a part of many people's everyday life, there is an ongoing need and desire to provide lamps that are of novel, aesthetically pleasing design.

Thus, there is a need and a demand for a lamp that while aesthetically pleasing is also of a form or shape that can also more easily or efficiently satisfy storage, packaging and/or transport requirements.

### SUMMARY OF THE INVENTION

According to a preferred embodiment of this invention, a lamp of this invention includes a base, a neck having a first end connected to the base and a second end opposite the first end, and a lamp head connected to the second end of the neck.

The lamp head includes first and second parallel major planar faces and a minor face perpendicular to the first and second parallel major planar faces and disposed therebetween. The first and second parallel major planar faces desirably congruently form an outline of a selected light-associated object.

The lamp head preferably also includes first and second light emitting sources disposed between the first and second parallel major planar faces. As described in greater detail below and in accordance with certain embodiments, the first light emitting source preferably externally emits light via at least a portion of the minor face. Further in accordance with certain embodiments, the second light emitting source preferably internally projects light to at least selectively illuminate at least a portion of the outlined light-associated object.

According to another preferred embodiment of this invention, a lamp of this invention includes a base, a neck having a first end connected to the base and a second end opposite the first end, and a lamp head connected to the second end of the neck.

The lamp head includes first and second parallel planar faces with a third face perpendicular to the first and second parallel major planar faces and disposed therebetween. The first and second parallel planar faces congruently form an outline of a selected light-associated object. The outline of the selected light-associated object encircles a hollow corresponding to a cross sectional view of the selected light-associated object.

The lamp head further includes first and second light emitting sources disposed between the first and second parallel planar faces. The first light emitting source externally emits light via at least a portion of the third face and the second light emitting source internally projects light to at least selectively illuminate at least a portion of the hollow to form an illuminated silhouette of the selected light-associated object.

Other objects and advantages will be apparent to those skilled in the art from the following detailed description taken in conjunction with the appended claims and drawings.

### BRIEF DESCRIPTION OF THE DRAWINGS

This invention is explained in greater detail below in view of exemplary embodiments shown in the drawings, wherein:

FIG. 1 is a perspective view of a naked reader lamp in accordance with one preferred embodiment of the invention.

FIG. 2 is a close-up perspective view of the head end portion of the naked reader lamp shown in FIG. 1 and showing the front facing externally light emitting face thereof.

FIG. 3 is a close-up perspective view of the head end portion of the naked reader lamp shown in FIG. 1 and showing the rearward facing light emitting face thereof.

FIG. 4 is a perspective view of a 3-head reader lamp in accordance with one preferred embodiment of the invention.

FIG. 5 is a front view of the 3-head reader lamp shown in FIG. 4.

FIG. 6 is an end view of the 3-head reader lamp shown in FIG. 4.

FIG. 7 is a perspective view of table top lamp in accordance with one preferred embodiment of the invention.

FIG. 8 is a perspective view of a floor torch lamp in accordance with one embodiment.

### DETAILED DESCRIPTION OF THE INVENTION

As described in greater detail below, the present invention provides lamps that while aesthetically pleasing are also generally of a form or shape that can also more easily or efficiently satisfy storage, packaging and/or transport requirements.

Turning first to FIG. 1, there is illustrated a naked reader floor lamp, generally designated by the reference numeral 10, in accordance with one preferred embodiment of the invention. The floor lamp 10 preferably includes a base 12, a neck 14 and a lamp head 16. Means of or for powering the lamp 10 of this invention may be provided by an internal DC power source (not shown), such as one or more batteries, or an external AC power source (not shown).

According to one embodiment of this invention, as shown in FIG. 1, base 12 comprises a support surface 20. The base 12 may have any desired shape sufficient to maintain the lamp 10 in a desired position. A preferred position for many lamp placements is an upright position. The broader practice of the invention is not, however, necessarily so limited as alternative, non-upright positions may be desired for various particular or specific lamp placements.

The support surface 20 is preferably, but not necessarily, generally flat to facilitate positioning of the lamp 10 on a flat surface such as a floor. Those skilled in the art and guided by the teachings herein provided will, however, appreciate that the invention herein described can alternatively be similarly practiced wherein a lamp in accordance with the invention is placed or disposed onto a surface such as formed by a furniture piece, such as, for example, a table or a chair, or other object.

The base 12 is preferably made of a rigid material, such as, for example, plastic, metal, wood or other similar natural or synthetic material and combinations thereof. According to an alternative embodiment of this invention (not shown), the base 12 comprises a releasable attachment mechanism, for fastening, mounting, or otherwise releasably attaching the base 12 to another object. For example, the base may comprise a clamp for clamping the lamp to a furniture piece.

As generally shown in FIG. 1, the lamp 10 further includes a neck 14. The neck 14 may be made of the same or different material as the base 12. In accordance with one embodiment, the neck can be of or include a telescoping construction such as to facilitate or permit compact transport or storage. The neck 14 preferably includes first end 24 connected to the base 12 and second end 26 opposite the first end 24. The second end 26 is connected to the lamp head 16.

The neck 14 may, if desired and as shown, include a bendable neck portion 28 such as near or adjacent the lamp head 16, for example, such that the position of the lamp head 16 can be appropriately selectively adjusted with respect to the base 12. The bendable neck portion 28 may be made of any material known to those skilled in the art such that the bendable neck portion 28 preferably maintains the adjusted position for a period of time and/or until the position of bendable neck portion 28 is re-adjusted again.

For example, the bendable neck portion 28 may be appropriately adjusted to direct light produced by the lamp 10 upwards, sideways, or downwards, as may be desired in particular situations or applications. The bendable neck portion 28 is preferably adjustable and re-adjustable to any desired position.

With further reference to FIGS. 2 and 3, the lamp 10 further includes a lamp head 16. The lamp head 16 has or includes first and second major generally planar faces, respectively designated 30 and 32. A third face 34 is perpendicular to the first and second parallel major planar faces 30 and 32, and, in one embodiment, is disposed therebetween.

As discussed further below, at least with regard to some embodiments, the third face 34 may be identified or referred to as a minor face.

As shown in FIGS. 1-3, the first and second parallel major planar faces 30 and 32 in accordance with a preferred embodiment congruently form an outline of a selected light-associated object 36, such as a track head lamp, for example. Those skilled in the art and guided by the teachings herein provided will however understand and appreciate that the invention can be practiced employing the outline of other desired selected light-associated objects and thus the broader practice of the invention is not necessarily limited to the utilization of the outline of specific or particular light-associated objects.

In one embodiment, the outline 36 encircles a hollow, generally designated by the reference numeral 40 and which generally corresponds to a cross sectional view of the selected light-associated object. For example, in the case of the lamp 10, the hollow 40 generally corresponds to a cross sectional view of a track head lamp.

The lamp 10 preferably includes at least two light emitting sources, individually designated 42 and 44, such as generally disposed between the first and second parallel major planar faces, 30 and 32. As perhaps best seen by reference to FIG. 2, the first light emitting source 42 externally emits light via at least a portion of the minor face 34. More specifically, in the illustrated embodiment, the minor face 34 includes a planar portion 46 whereat the first light emitting source 42 externally emits light. In one embodiment, the first light emitting source 42 is an LED strip providing directional light.

Now referring to FIG. 3, the second light emitting source 44 projects light to at least selectively illuminate at least a portion of the outlined light-associated object 36. For example, light projected from the second light emitting source 44 can act to illuminate at least an internal portion 50 of the outlined selected light-associated object 36. In accordance with certain preferred embodiments, the second light emitting source 44 that projects light to at least selectively illuminate at least a portion of the outlined light-associated object 36 desirably internally projects colored light of a desired selected hue such as to provide a desired ambient glow to the outlined selected light-associated object 36. In one embodiment the second light emitting source 44 internally projects light to at least selectively illuminate at least a portion of the hollow 40 to form an illuminated silhouette of the selected light-associated object.

The lamp 10 preferably includes at least two light emitting sources, individually designated 42 and 44, disposed between the first and second parallel major planar faces, 30 an 32. According to one embodiment of this invention, at least one of the light emitting sources is a light-emitting diode (LED). Preferably, the at least one light-emitting diode (LED) is selected from the group consisting of a white light-producing LED, a red light-producing LED, a blue light-producing LED, a green light-producing LED, and combinations thereof. In one preferred embodiment of this invention, the emitting sources comprise a plurality of light-emitting diodes (LEDs).

In one embodiment of this invention, the lamp 10 comprises a first light emitting source 42 comprising a plurality of white-light producing LEDs, which, when in operation, provide task lighting. In one embodiment of this invention, the lamp 10 comprises a second light emitting source 44 comprising a plurality of colored light-producing LEDs, which, when in operation, provide color-phasing lighting. The plurality of colored light-producing LEDs preferably comprise at least one red light-producing LED, at least one blue light-producing LED and/or at least one green light-producing LED.

Such as is known in the art, the lamp can, as may be desired, include one or more switches (not shown) for activating and/or deactivating light emitting sources, as well as electrical/electronic wiring (not shown) for operatively connecting the light emitting source to one or more internal and/or external power source.

As will be appreciated, the lamp 10 while aesthetically pleasing is also of a form or shape that can also more easily or efficiently satisfy storage, packaging and/or transport requirements. For example, the lamp head 16 and lamp base 12 can be packaged as relatively flat items and with a selected neck, such as described above, facilitate or permit compact transport or storage of such a lamp.

Turning now to FIG. 4-6, there is illustrated a 3-head reader lamp 110 in accordance with one preferred embodiment of the invention and with which the relatively flat profile of lamps in accordance with certain preferred embodiments of the invention can be more easily appreciated, recognized and/or realized.

Similar to the floor lamp 10 described above, the 3-head reader lamp 110 preferably includes a base 112, a neck 114 and, in this case, three lamp heads 116, 117 and 118. Means of or for powering the lamp 110 of this invention may be provided by an internal DC power source (not shown), such as one or more batteries, or an external AC power source (not shown). Similarly, the lamp 110 can, as may be desired, include one or more switches (not shown) for activating and/or deactivating light emitting sources, as well as electrical/electronic wiring (not shown) for operatively connecting the light emitting source to one or more internal and/or external power source.

Similar to the lamp head 16, described above, each of the lamps heads 116, 117 and 118 includes first and second major generally planar faces, respectively designated 130 and 132. A third face 134 is perpendicular to the first and second parallel major planar faces 130 and 132, and is disposed therebetween. In accordance with a preferred embodiment, the first and second parallel major planar faces 130 and 132 of at least one and preferably of each of the lamp heads 116, 117 and 118 congruently form an outline of a selected light-associated object 136 such as a track head lamp. While in FIGS. 4-6, the lamp heads 116, 117 and 118 each form an outline of the same or similar selected light-associated object, the broader practice of the invention is not necessarily so limited. For example, is desired, a lamp in accordance with the invention can be constructed utilizing a different outline of a selected light-associated object for one or more of the lamp heads of or on a particular lamp.

Similar to the lamp head 16, described above, at least one and preferably each of the lamp heads 116, 117 and 118 preferably includes at least two light emitting sources, individually designated 142 and 144, disposed between the first and second parallel major planar faces, 130 and 132 and whereby the first light emitting source 142 externally emits light via at least a portion of the minor face 134 and the second light emitting source 144 projects light to at least selectively illuminate at least a portion of the outlined light-associated object 136.

Turning now to FIG. 7, there is illustrated a table top lamp 210 in accordance with one preferred embodiment of the invention.

Similar to the floor lamp 10 described above, the table top lamp 210 preferably includes a base 212, a neck 214 and a lamp head 216. Means of or for powering the lamp 210 of this invention may be provided by an internal DC power source (not shown), such as one or more batteries, or an external AC power source (not shown). Similarly, the lamp 210 can, as may be desired, include one or more switches (not shown) for activating and/or deactivating light emitting sources, as well as electrical/electronic wiring (not shown) for operatively connecting the light emitting source to one or more internal and/or external power source.

According to one embodiment of this invention, as shown in FIG. 7, the base 212 comprises a cross tension fit construction 220. As will be appreciated by those skilled in the art and guided by the teachings herein provided, however, the base 212 may have any desired shape sufficient to maintain the lamp 210 in a desired position. For example, suitable base structures for use in or with lamps in accordance with the invention can include bases formed of or having a notch pierce through bottom, a notch cupped bottom, a notch wire and notch clip construction.

Similar to the lamp head 16, described above, the lamp head 216 includes first and second major generally planar faces, respectively designated 230 and 232. A third face 234 is perpendicular to the first and second parallel major planar faces 230 and 232, and is disposed therebetween. In accordance with a preferred embodiment, the first and second parallel major planar faces 230 and 232 congruently form an outline of a selected light-associated object 236, such as a track head lamp, for example.

Similar to the lamp head 16, described above, the lamp head 216 preferably includes at least two light emitting sources, individually designated 242 and 244, disposed between the first and second parallel major planar faces, 230 and 232 and whereby the first light emitting source 242 externally emits light via at least a portion of the minor face 234 and the second light emitting source 244 projects light to at least selectively illuminate at least a portion of the outlined light-associated object 236.

In one embodiment, the lamp head 216 includes a planar element 260 at least in part disposed within the outline of the selected light-associated object 236. In one embodiment, the planar element 260 can be transparent or, if desired, clear and may serve as a means for conveying the light that projects from the second light emitting source 244. The planar element 260 can act or serve to limit, restrict or otherwise appropriately direct the light projected from the second light source 244. The planar element 260 can, for example, be made of glass, plastic or any other suitable natural or synthetic material known to those skilled in the art

Turning to FIG. 8, there is illustrated a torch lamp 310 in accordance with another embodiment of the invention.

The torch lamp 310 preferably includes a base 312, a neck 314 and a lamp head 316. Means of or for powering the lamp 310 may be provided by an internal DC power source (not shown), such as one or more batteries, or an external AC power source (not shown). The lamp 310 can, as may be desired, include one or more switches (not shown) for activating and/or deactivating light emitting sources, as well as electrical/electronic wiring (not shown) for operatively connecting the light emitting source to one or more internal and/or external power source.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A lamp comprising:
a base;
a neck having a first end connected to the base and a second end opposite the first end; and
a lamp head connected to the second end of the neck, the lamp head having:
first and second parallel major planar faces and a minor face perpendicular to the first and second parallel major planar faces and disposed therebetween, the first and second parallel major planar faces congruently form an outline of a selected light-associated object and
first and second light emitting sources disposed between the first and second parallel major planar faces, wherein the first light emitting source externally emits light via at least a portion of the minor face and the second light emitting source projects light to at least selectively illuminate at least a portion of the outlined light-associated object.

2. The lamp of claim 1 wherein the second light emitting source internally projects colored light.

3. The lamp of claim 1 wherein the light-associated object is a track head lamp.

4. The lamp of claim 1 wherein at least one of the first and second light emitting sources comprises a LED strip.

5. The lamp of claim 4 wherein the first light emitting source is an LED strip providing directional light.

6. The lamp of claim 4 wherein the second light emitting source is a color LED strip providing ambient glow to the outlined selected light-associated object.

7. The lamp of claim 1 wherein the minor face includes at least one planar portion whereat the first light emitting source externally emits light.

8. The lamp of claim 1 wherein light projected from the second light emitting source illuminates at least an internal portion of the outlined selected light-associated object.

9. The lamp of claim 1 additionally comprising a transparent planar element at least in part disposed within the outline of the selected light-associated object.

10. The lamp of claim 9 wherein light projected from the second light emitting source illuminates at least a portion of the transparent planar element at least in part disposed within the outline of the selected light-associated object.

11. The lamp of claim 1 wherein the neck is bendable.

12. A lamp comprising:
a base;
a neck having a first end connected to the base and a second end opposite the first end; and
a lamp head connected to the second end of the neck, the lamp head having:
first and second parallel planar faces with a third face perpendicular to the first and second parallel major planar faces and disposed therebetween, the first and second parallel planar faces congruently form an outline of a selected light-associated object, the outline encircling a hollow corresponding to a cross sectional view of the selected light-associated object and
first and second light emitting sources disposed between the first and second parallel planar faces, wherein the first light emitting source externally emits light via at least a portion of the third face and the second light emitting source internally projects light to at least selectively illuminate at least a portion of the hollow to form an illuminated silhouette of the selected light-associated object.
